(19) United States
(12) Patent Application Publication
(10) Pub. No.: US 2005/0163658 A1
(43) Pub. Date: Jul. 28, 2005

(54) Interrupted, vertical flow testing device

(76) Inventors: Naishu Wang, San Diego, CA (US); David F. Zhou, San Diego, CA (US)

Correspondence Address: CHARMASSON & BUCHACA & LEACH LLP, 1545 HOTEL CIRCLE SOUTH, SUITE 150, SAN DIEGO, CA, 92108-3412, US

(21) Appl. No.: 10/767,897

(22) Filed: Jan. 28, 2004

(51) Int. Cl. G01N 31/22

(52) U.S. Cl. 422/56

(57) ABSTRACT

In a vertical flow immunoassay testing device, the fluid specimen is deposited in a sampling well whose inclined walls and filtration material separate mucus and other adhesive matters from the more fluid components. The mixing of the specimen with a buffer solution is triggered by the closure of the device's cap. The flow of the buffered specimen from a first chamber where it is exposed to a collodial gold conjugate to a second chamber holding a chromatographic test strip is temporarily interrupted by a holding reservoir. The specimen does not freely flow into the strip until the reservoir begins to overflow. The delay provides an incubation time for a better affinity binding of the specimen and regulates its flow through the strip.

### FIELD OF THE INVENTION

This invention relates to analytical and confirmatory testing devices for analyzing body fluids using immunochromatography, and more particularly to apparatuses for concurrent performances of multiple antibody, or antigen detection on a common fluid test.

### BACKGROUND OF THE INVENTION

Over past decades, the prior art has offered several types of rapid diagnostic testing techniques. First, were the latex particle agglutination tests, then the Flow Through tests leading to the current Lateral Flow Single Step test. To this day, the Western Blot Analytical Assay is the only one reliably used for the confirmatory detection of HIV infection in a clinical laboratory setting. Due to its multi-step manipulation and verification phases, this type of assay takes days, if not weeks. There is no practical confirmatory rapid diagnostic testing technique for use in a Point-of-Care setting, available in the market place today.

The instant invention results from an attempt to refine the accuracy and expedite the performances of chromatographic rapid testing devices to a higher and new level.

### SUMMARY OF THE INVENTION

The principal and secondary objects of the invention are to provide a device to rapidly and accurately conduct an immunoassay flow through test that can instantly provide a detection, analysis and confirmation of HIV infection by way of a simple, inexpensive and disposable instrument that can be manipulated safely by a relatively low skill person. An additional goal is to maintain the benefit of the dry chemistry, such as in Lateral Flow test method for an economically prolonged room temperature shelf life of at least 24 months.

These and other valuable objects are achieved by a device contained in a molded enclosure in which the primary exposure of a body fluid in a buffered solution to a first HIV specific antigen in a colloidal conjugate is done in a first chamber before the antigen-loaded specimen is contacted with chromatographic strips in a second chamber. A holding reservoir located between the first and the second chambers temporarily restrict the flow of the wash to allow a short period of incubation before proceeding with the chromatographic reaction. The testing strips are preferably coated with a number of epitopes which are immuno-determinant of the presence of HIV virus. According to standard procedure, the appearance of at least two epitope lines on a strip, not only confirms the presence of the HIV virus, but also give an analytical indication of the type of antibodies present in the specimen. The strip also includes a control line.

A supply of aqueous buffer solution is held in a sealed vessel until the sample specimen has been introduced into the device and the cap has been closed. A prong in the undersurface of the cap punctures a membrane sealing the upper opening of the vessel allowing the buffer solution to be dispensed into the first chamber under atmospheric pressure. A pad at the bottom of the second chamber in contact with a lower part of the strips absorbs the excess wash buffer that has not been retained by the strip. The strips can be positioned in an incline rather than straight vertical position in order to reduce the height of the device. The flow out of the incubation reservoir and into the strip is prompted by a combination of capillarity, gravity and siphoning action forces.

### BRIEF DESCRIPTION OF THE DRAWINGS

FIG. 1 is a diagrammatical illustration of the interrupted flow testing device according to the invention; and

FIG. 2 is a perspective view of the device.

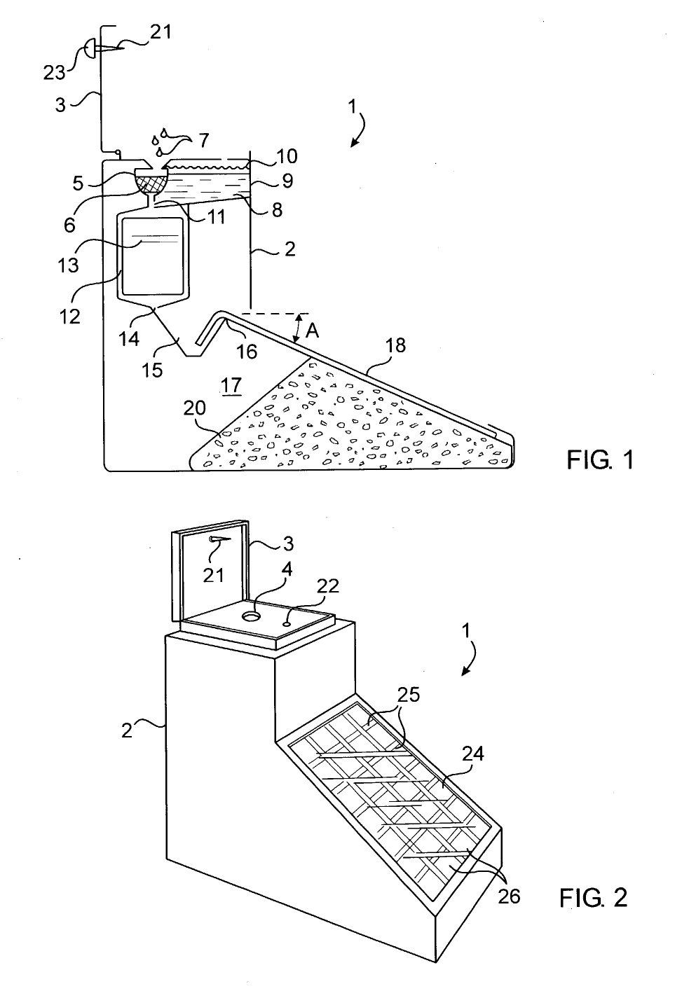

### DESCRIPTION OF THE PREFERRED EMBODIMENT OF THE INVENTION

Referring now to the drawing, there is shown an immunoassay testing device 1 according to the invention. The device is preferably packaged in a molded plastic enclosure 2 topped by a sealing cap 3. In the upper region of the device, and immediately under a ceiling hole 4 is a sampling well 5. The internal wall of the well is funnel-shaped, and retains some filtration material 6. The geometry of that wall, whether in the form of a V or a U, has a portion of a relatively low pitch so that when a fluid specimen 7 such as whole blood, 7 or saliva runs along the wall, particles and adhesive matters are separated from the fluid component of the specimen. A supply of aqueous buffering solution 8 is held in a vessel 9 along side the sampling well. The vessel has a top opening hermetically sealed by a membrane 10, and a dispensing port 11 in a lower region leading to a first chamber 12 in a first analytical part of the device. The chamber is located immediately below the sampling well and receives the fluid component. That first chamber holds colloidal gold conjugated specific HIV antigen or other colloidal conjugate 13 that reacts with the fluid specimen in its buffered solution.

An outlet 14 at the bottom of the chamber leads to an incubation reservoir 15 in which the solution flowing from the chamber accumulates and rests until the level of the solution reaches an upper part of the reservoir where an escape port 16 leads to a second chamber 17 holding one or more chromatographic testing strips 18. The strip 18 is preferably positioned in an inclined position at a pitch angle A of at least 15 degrees from the horizontal. The upper edge 19 of the strip dips into the reservoir and is contacted by the solution that flows down slowly under the effect of capillarity, gravity and siphoning forces enhanced by an absorbing pad 20 positioned in the bottom of the enclosure and in contact with the lower portion of the strip 18.

The strip is coated with a number of epitopes that are immuno-determinant of the HIV virus such as p18, p24, p32, gp36, gp41, p51, p55, p65, gp120, gp160 and subtype o, etc.

It should be noted that the dispensing of the buffer solution 8 out of the vessel 9 is triggered by puncturing the membrane 10. The puncturing is accomplished by a prong 21 which extends from the underside of the cap 3 and passes through an aperture 22 in the roof of the enclosure. The prong is normally held into a retracted position during storage and shipment of the device, but can be moved to an extended position by manipulating a knob 23 on the outside of the cap. The prong is positioned, shaped and dimensioned to extend sufficiently through the aperture 22 into rupturing contact with the membrane 10.

The buffer solution 8 washes and carries the components of the specimen that comes down from the sampling well and provide the volume of fluid necessary 15 to fill the incubation reservoir and thus, regulate the transfer of the specimen through the device. By adjusting the volume of buffer solution to what is necessary to create a minor overflow of the reservoir, excessive flooding of the test strip is avoided.

It should be understood that the flow-interrupting reservoir 15 can assume a variety of positions and configurations that provides a temporary, but longer incubation time for the buffered sampling solution to complete the first affinity binding of the immunno-chemical reaction before it is contacted with the chromatographic testing strip to form the second affinity binding of the Immuno-Chemical reaction, forming the double Antigen sandwich-immuno complex. A transparent window 24 sealed to the enclosure provides a direct viewing of chromatographic test lines 25 appearing on a number of test strips 26.

While the preferred embodiment of the invention has been described, modifications can be made and other embodiments may be devised without departing from the spirit of the invention and the scope of the appended claims.

1. In an immunoassay flow testing device wherein a fluid specimen in a buffered solution is first contacted with a colloidal conjugate in a first part of said device, then applied to a chromatographic testing strip in a second part of said device, an improvement which comprises a flow interrupting reservoir between said first and said second parts.

2. The improvement of claim 1 which further comprises means for restricting flow from said reservoir to said strip.

3. The improvement of claim 2, wherein said means for restricting comprises an escape port in an upper part of said reservoir.

4. A flow immunoassay testing device which comprises:
a first chamber holding a colloidal gold conjugate;
a second chamber holding at least one chromatographic testing strip; and
a flow-interrupting reservoir of a given capacity between said first and second chambers.

5. The device of claim 4 which further comprises:
a supply of buffer liquid; and
means for triggering the dispensing of said supply into said first chamber.

6. The device of claim 5 which further comprises a sampling well in communication with said first chamber.

7. The device of claim 6, wherein said sampling well comprises a funnel-shaped internal wall.

8. The device of claim 5, wherein said means for dispensing comprises:
a vessel holding said supply of buffer, said vessel having an opening in an upper region and a dispensing port in a lower region;
a membrane sealing said opening; and
means for puncturing said membrane to allow dispensing of said supply through said port under atmospheric pressure.

9. The device of claim 8, wherein said device further comprises a cap covering said sampling well and vessel; and
at least one prong extending from said cap toward said membrane, said prong being shaped and dimensioned to puncture said membrane when said cap is placed over said sampling well and vessel.

10. The device of claim 5 which further comprises an absorbing pad in contact with a portion of said strip.

11. The device of claim 4, wherein said reservoir has an escape port in an upper part thereof;
whereby a liquid wash from said first chamber must accumulate into said reservoir up to the level of said escape port before flowing freely into said second chamber.

12. The device of claim 6 which further comprises filtration material in said sampling well.

13. The device of claim 5, wherein said supply of buffer liquid is adjusted to create a minor overflow of said reservoir.

14. The device of claim 4, wherein said second chamber holds a plurality of strips each having a plurality of chromatographic test lines.
